(19) United States
(12) Patent Application Publication
(10) Pub. No.: US 2015/0335408 A1
(43) Pub. Date: Nov. 26, 2015

(54) Disposable Flossing Assembly

(71) Applicants: D. Harvey Lee, Irvine, CA (US); John Raybuck, Tustin, CA (US)

(72) Inventors: D. Harvey Lee, Irvine, CA (US); John Raybuck, Tustin, CA (US)

(21) Appl. No.: 14/540,948

(22) Filed: Nov. 13, 2014

Related U.S. Application Data
(60) Provisional application No. 62/002,655, filed on May 23, 2014.

(51) Int. Cl. A61C 15/04

(52) U.S. Cl. CPC A61C 15/046

(57) ABSTRACT

An apparatus and method are provided for flossing interproximal spaces between adjacent teeth in the presence of orthodontic braces and an arch-wire. The apparatus comprises a handle portion and a floss support portion comprising a first elongate member and a second elongate member separated by an intervening concave recess. The first elongate member comprises a narrow section and an angled first floss support, and the second elongate member comprises a narrow section and a second floss support. A floss strand extends under tension at an acute angle from the angled first floss support to the second floss support at substantially a right angle. The acute angle facilitates positioning the first floss support between a patient's upper teeth and the arch-wire while passing the floss strand into the interproximal space between the upper teeth. The substantially right angle facilitates positioning the floss strand into the interproximal spaces between the lower teeth.

### CROSS REFERENCE TO PRIORITY APPLICATION

This application claims the benefit of and priority to U.S. Provisional application, entitled “TidyFloss (a flossing tool for easily and quickly flossing teeth with braces),” filed on May 23, 2014 having application Ser. No. 62/002,655.

### FIELD OF THE INVENTION

The field of the invention generally relates to dental flossing devices. More specifically, the field of invention generally relates to an apparatus and a method for flossing interproximal spaces between teeth in the presence of orthodontic braces and an arch-wire.

### BACKGROUND

An orthodontic arch-wire generally is a metal wire configured to conform to a dental arch and coupled with dental braces as a source of force so as to correct irregularities in the positions of teeth. An arch-wire often times may be employed for retentive purposes so as to maintain existing dental positions. Orthodontic arch-wires typically are comprised of a metal alloy, such as stainless steel, nickel-titanium alloy, or beta-titanium alloy.

As will be appreciated, using dental floss to remove food particles and plaque from interproximal areas between teeth that a toothbrush can't reach is a critical component of oral care. Once dental braces and an arch-wire are installed, however, flossing generally requires more time and patience on the part of a patient because the arch-wire blocks the floss. One approach to flossing with the arch-wire present is to string a piece of floss under the arch-wire, then wrap the ends of the floss tightly around the fingers, and then proceed to floss the space between the teeth. A drawback to this approach is that it must be repeated for each interproximal space in the upper and lower teeth, and thus tends to be time consuming and laborious.

Another approach to flossing teeth in the presence of an arch-wire is to use a floss threader. Generally, a floss threader comprises a small piece of plastic filament with a loop at one end, resembling a soft sewing needle, whereby the floss may be drawn under or over the arch-wire so that typical flossing may be performed. Although the floss threader simplifies threading the floss around the arch-wire, a drawback to this approach is that the patient must still repeat the procedure for each interproximal space in the upper and lower teeth, and thus even when using the floss threader, flossing with braces remains a time consuming and laborious task. What is needed, therefore, is a tool for quickly and simply flossing a patient's entire mouth with braces and an arch-wire installed on the patient's teeth.

### SUMMARY

An apparatus and method are provided for flossing an interproximal space between adjacent teeth in the presence of orthodontic braces and an arch-wire. The apparatus comprises a handle portion and a floss support portion comprising a first elongate member and a second elongate member separated by an intervening concave recess. The first elongate member comprises a narrow section and an angled first floss support, and the second elongate member comprises a narrow section and a second floss support. A floss strand extends under tension at an acute angle from the angled first floss support to the second floss support at substantially a right angle. The acute angle facilitates positioning the first floss support between a patient's upper teeth and the arch-wire while passing the floss strand into the interproximal space between adjacent teeth. The substantially right angle facilitates positioning the floss strand into the interproximal spaces between adjacent lower teeth.

In an exemplary embodiment, an apparatus for flossing an interproximal space between adjacent teeth in the presence of orthodontic braces and an arch-wire comprises a handle portion; a floss support portion comprising a first elongate member and a second elongate member separated by an intervening concave recess, the first elongate member comprising a narrow section and a first floss support joined by an intervening bend, the second elongate member comprising a narrow section and a second floss support; and a floss strand extending under tension at an acute angle from the first floss support to the second floss support at substantially a right angle; wherein the acute angle facilitates positioning the first floss support between a patient's upper teeth and the arch-wire while simultaneously passing the floss strand into the interproximal space between the teeth; and wherein the substantially right angle facilitates positioning the second floss support between the patient's lower teeth and the arch-wire while simultaneously passing the floss strand into the interproximal spaces between teeth.

In another exemplary embodiment, the floss support portion is positioned at an angle relative to the handle portion so as to facilitate engaging the floss support portion with the interproximal space while comfortably grasping the handle portion in a hand. In another exemplary embodiment, the floss strand comprises a material possessing a tensile strength suitable to withstand tension exerted on the floss strand due to the first and second elongate members, and tension arising on the floss strand during insertion into the interproximal spaces between teeth. In another exemplary embodiment, the floss strand comprises a lubricous coating of wax, parylene, or other similar material. In another exemplary embodiment, the first and second elongate members comprise a flexible material which is rigid enough to maintain the floss strand under a degree of tension suitable to pass the strand into tight interproximal spaces between closely neighboring teeth. In another exemplary embodiment, the intervening concave recess is configured to accommodate the teeth when the floss strand is within the interproximal space between the teeth.

In another exemplary embodiment, the narrow sections extend from the intervening concave recess at an acute angle relative to one another, the second floss support being substantially parallel with the narrow section, and the bend positioning the first floss support at an oblique angle relative to the narrow section. In another exemplary embodiment, the acute angle between the narrow sections and the oblique angle position the first floss support at a cumulative angle relative to the second floss support. In another exemplary embodiment, the cumulative angle between the first and second floss supports ranges between 15 degrees and 25 degrees.

In another exemplary embodiment, the first and second floss supports each comprises a width resembling a shovel shape, wherein the supports widen in extending from the narrow sections and then taper distal of the floss strand, and wherein a thickness of each of the first and second floss supports is less than a distance between the arch-wire and the patient's teeth. In another exemplary embodiment, the thickness of the first floss support allows the first floss support to pass between the arch-wire and the patient's upper teeth when the floss strand is inserted into the interproximal space between neighboring upper teeth. In another exemplary embodiment, the thickness of the second floss support enables the second floss support to pass between the arch-wire and the patient's lower teeth when the floss strand is inserted into the interproximal space between neighboring lower teeth.

In another exemplary embodiment, the floss support portion comprises a flexible material which is rigid enough to maintain the floss strand under a level of tension suitable to pass the strand into tight interproximal spaces between closely neighboring teeth. In another exemplary embodiment, the apparatus is fabricated using standard plastic molding technology. In another exemplary embodiment, the apparatus comprises between 1% and 50% glass filled polymer. In another exemplary embodiment, the apparatus comprises Polyolefin, thermoplastic elastomers, thermoplastic vulcinates, polymers and copolymers of polylactic acid, polystyrene, polyester, polyoxamethalyne, cellulosics, polyamides, polyamideimides, polybutylene-terephthylate, polyester elastomers, linear low density polyethylene, thermoplastic polyurethane, bi-axially oriented polypropylene, ethylene copolymers, Polyvinylchloride, block copolyetheresters derived from hydroxyl-terminated polyethers, polycarbonates, polyestercarbonates, polyketones, polysulfones, polyethersulfones, polyetherketones; unsaturated polyesters derived from copolyesters of saturated and unsaturated dicarboxylic acids, crosslinked acrylic resins derived from substituted acrylates, starch, cellulose, polyhydroxy alcanoates (PHA), polycaprolactone (PCL), polybutylene succinate (PBS)), polymers and copolymers of N-vinylpyrrolidone, polymethylpentene, Methyl methacrylate-acrylonitrile-butadiene-styrene, polytetrafluoroethylene, polyphenylene oxide, polyphenylene sulfide, polyacrylonitrile, polycyanoacrylate, polyvinylpyrrolidone, polydicyclopentadiene, polyimides, aramids, polybutadiene, acrylonitrile-styrene, paracyclophane, parylene, ethylene vinyl alcohol, polyamide (nylon), or any combination thereof.

In an exemplary embodiment, a method for flossing an interproximal space between adjacent teeth in the presence of orthodontic braces and an arch-wire comprises fabricating a dental flossing assembly comprising a handle portion and a floss support portion; positioning the floss support portion at an angle relative to the handle portion so as to facilitate engaging the floss support portion with the interproximal space while comfortably grasping the handle portion in a hand; separating a first elongate member and a second elongate member on opposing sides of an intervening concave recess, such that the first and second elongate members extend from the concave recess at an acute angle relative to one another, the first elongate member comprising a narrow section and a first floss support, the second elongate member comprising a narrow section and a second floss support, the intervening concave recess sized to accommodate the adjacent teeth during flossing; joining the first floss support and the narrow section together way of an intervening bend so as to position the first floss support at an oblique angle relative to the narrow section; extending a floss strand under tension at an acute angle from the first floss support to the second floss support at substantially a right angle; positioning the first floss support between a patient's upper teeth and the arch-wire while passing the floss strand into the interproximal space between the upper teeth; and positioning the second floss support between the patient's lower teeth and the arch-wire while passing the floss strand into the interproximal space between the lower teeth.

In another exemplary embodiment, joining further comprises forming a cumulative angle between the first and second floss supports ranging between 15 degrees and 25 degrees. In another exemplary embodiment, fabricating further comprises using standard plastic molding technology. In another exemplary embodiment, fabricating further comprises forming a thickness of the first and second floss supports which is less than a distance between the patient's teeth and the arch-wire.

### BRIEF DESCRIPTION OF THE DRAWINGS

The drawings refer to embodiments of the present invention in which:

FIG. 1 illustrates a front perspective view of an exemplary embodiment of a disposable flossing assembly in accordance with the present disclosure;

FIG. 2 illustrates a side view of an exemplary embodiment of a disposable flossing assembly, according to the present disclosure; and

FIG. 3 illustrates a front view of an exemplary embodiment of a disposable flossing assembly in accordance with the present disclosure.

While the present invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present invention.

### DETAILED DESCRIPTION

In the following description, numerous specific details are set forth in order to provide a thorough understanding of the present invention. It will be apparent, however, to one of ordinary skill in the art that the present invention may be practiced without these specific details. In other instances, specific numeric references such as “first floss support,” may be made. However, the specific numeric reference should not be interpreted as a literal sequential order but rather interpreted that the “first floss support” is different than a “second floss support.” Thus, the specific details set forth are merely exemplary. The specific details may be varied from and still be contemplated to be within the spirit and scope of the present invention. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present invention describes an apparatus and a method for flossing an interproximal space between teeth in the presence of orthodontic braces and an arch-wire. The apparatus comprises a handle portion and a floss support portion comprising a first elongate member and a second elongate member separated by an intervening concave recess. The floss support portion is positioned at an angle relative to the handle portion so as to facilitate engaging the floss support portion with the interproximal space while comfortably grasping the handle portion in hand. The first elongate member comprises a narrow section and an angled first floss support, and the second elongate member comprises a narrow section and a second floss support. A thickness of each of the first and second floss supports preferably is less than a distance between the arch-wire and the patient's teeth. A floss strand extends under tension at an acute angle from the angled first floss support to the second floss support at a substantially right angle. The floss strand preferably comprises a lubricous coating of wax, parylene, or other similar material. The acute angle facilitates positioning the first floss support between a patient's upper teeth and the arch-wire while passing the floss strand into the interproximal space between the teeth. The substantially right angle facilitates positioning the floss strand into the interproximal spaces between lower teeth. The first and second elongate members, including the first and second floss supports, comprise a flexible material which is rigid enough to maintain the floss strand under a level of tension suitable to pass the strand into tight interproximal spaces between closely neighboring teeth.

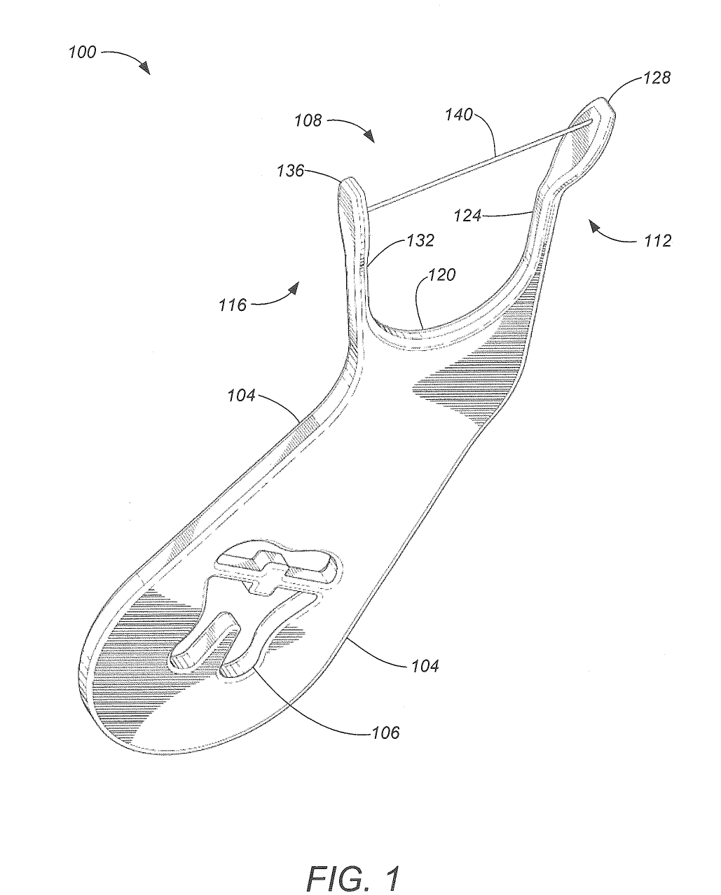

FIG. 1 is a front perspective view of an exemplary embodiment of a disposable flossing assembly 100 in accordance with the present disclosure. The disposable flossing assembly 100 comprises a handle portion 104 and a floss support portion 108. In the illustrated embodiment of FIG. 1, the handle portion 104 includes a logo 106 resembling a tooth. In other embodiments, the logo 106 may be fashioned to resemble shapes or symbols other than as illustrated in FIG. 1. For example, it is envisioned that in other embodiments, the logo 106 may be implemented as a company logo, any of a variety of dental-related symbols, dental-oriented text, and the like. As further illustrated in FIG. 1, the floss support portion 108 is positioned at an angle relative to the handle portion 104. It will be appreciated that the angle facilitates engaging the floss support portion 108 with the interproximal spaces between teeth for flossing purposes while the handle portion 104 generally is comfortably grasped in a hand. As discussed in more detail below, the disposable flossing assembly 100 is particularly well suited for flossing teeth in patients wherein an orthodontic arch-wire is coupled with dental braces. Thus, the disposable flossing assembly 100 advantageously increases flossing compliance with orthodontic arch-wires, braces, and other similar dental treatments.

The floss support portion 108 comprises a first elongate member 112 and a second elongate member 116 separated by an intervening concave recess 120. In the illustrated embodiment of FIG. 1, the first and second elongate members 112, 116 generally extend from opposing sides of the concave recess 120. The first elongate member 112 comprises a narrow section 124 and a first floss support 128. Similarly, the second elongate member 116 comprises a narrow section 132 and a second floss support 136. A floss strand 140 extends under tension from the first floss support 128 to the second floss support 136. In an embodiment, the floss strand 140 comprises a round cross-sectional shape, having a diameter suitable for teeth flossing purposes. In some embodiments, however, the floss strand 140 may comprise a ribbon, having a thickness which is smaller than a width of the ribbon. As will be appreciated by one skilled in the art, the thickness of the ribbon reduces friction between the ribbon and the teeth, thereby facilitating passing the ribbon into tight interproximal spaces between closely neighboring teeth. The floss strand 140 preferably comprises a lubricous coating of wax, parylene, or other similar material, so as to reduce friction between the floss strand and the teeth. Further, it is envisioned that the first and second elongate members 112, 116 comprise a flexible material which is rigid enough to maintain the floss strand 140 under a degree of tension suitable to pass the strand into tight interproximal spaces between closely neighboring teeth. It will be appreciated that the level of friction arising between the floss strand 140 and the teeth has an impact on the degree of tension applied to the floss strand 140, and thus friction also impacts the type of material that may be used for the floss strand. Thus, the lubricous coating advantageously facilitates using a material for the floss strand 140, possessing a lower tensile strength than otherwise possible. The concave recess 120 preferably comprises a size suitable to accommodate the neighboring teeth when the floss strand 140 is within the interproximal space between the teeth. It is envisioned that the concave recess 120 is large enough to allow the floss strand 140 to be pivoted to various angles between the teeth without the teeth coming into contact with the narrow sections 124, 132.

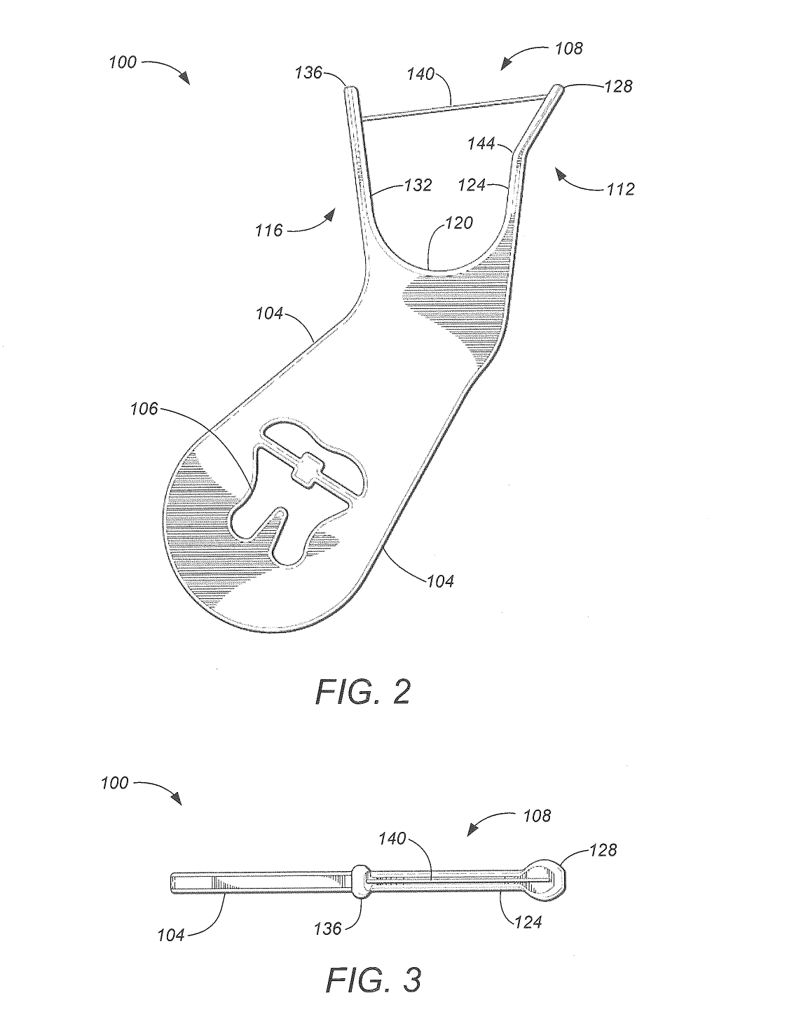

As best illustrated in FIG. 2, the narrow sections 124, 132 are positioned at an acute angle relative to one another. The second floss support 136 is substantially parallel with the narrow section 132. Conversely, the first floss support 124 is joined to the narrow section 124 at an oblique angle by way of a bend 144. It will be recognized that the acute angle between the narrow sections 124, 132 and the oblique angle due to the bend 144 position the first floss support 128 at a cumulative angle relative to the second floss support 136. Preferably, the cumulative angle between the first and second floss supports 128, 136 ranges between 15 degrees and 25 degrees. Accordingly, the floss strand 140 is attached to the first floss support 128 at an acute angle, whereas the floss strand 140 is attached to the second floss support 136 at substantially a right angle. The acute angle between the floss strand 140 and the first floss support 128 facilitates positioning the first floss support 128 between the patient's teeth and the orthodontic arch-wire while simultaneously passing the floss strand 140 into the interproximal spaces between the upper teeth. The substantially right angle between the floss strand 140 and the second floss support 136 facilitates positioning the floss strand 140 into the interproximal spaces between the lower teeth. It will be recognized that the angles between the floss strand 140 and the first and second floss supports 128, 132 advantageously enables a greater use of the entire length of the floss strand 140 without the patient having to flip the floss support portion 108 up and down respectively for flossing upper and lower teeth.

As best illustrated in FIGS. 1 and 3, the first and second floss supports 128, 136 each comprises a width resembling a shovel shape, wherein the supports widen as they extend from the narrow sections and then taper distal of the location of the floss strand 140. The width of each of the first and second floss supports 128, 136 is greater than a width of the narrow sections 124, 132, so as to provide structural support to the tensioned floss strand 140. Further, a thickness of the first and second floss supports 128, 136 is substantially equal to the thickness of the narrow sections 124, 132, as best illustrated in FIG. 2. The thickness of the first and second floss supports 128, 136 preferably is less than a distance between the arch-wire and the patient's teeth. The thickness of the first floss support 128 advantageously allows the first floss support to pass between the arch-wire and the patient's upper teeth when the floss strand 140 is inserted into the interproximal space between neighboring upper teeth. Similarly, the thickness of the second floss support 136 enables the second floss support to pass between the arch-wire and the patient's lower teeth when the floss strand 140 is inserted into the interproximal space between neighboring lower teeth.

The first and second floss supports 128, 136, as well as the aforementioned elongate members 112, 116, preferably comprise a flexible material which is rigid enough to maintain the floss strand 140 under a level of tension suitable to pass the strand into tight interproximal spaces between closely neighboring teeth. Further, it is envisioned that the floss strand 140 is comprised of a material possessing a tensile strength suitable to withstand the tension exerted on the floss strand due to the first and second floss supports 128, 136, as well an additional tension arising on the floss strand during insertion into the interproximal spaces between teeth. Further still, it is envisioned that in some embodiments, the floss strand 140 may be installed onto and removed from the first and second floss supports 128, 136 by the patient. It will be appreciated that in such embodiments, the patient may engage a new floss strand with the first and second floss supports 128, 136 prior to each flossing session, and thus the floss assembly 100 need not be disposed of after each flossing session. It is envisioned that in such embodiments, the first and second floss supports 128, 136 are configured to receive patient-installed floss strands.

The disposable flossing assembly 100 may be fabricated using standard plastic molding technology, such as insert injection molding. Preferably, the disposable flossing assembly 100 comprises between 1% and 50% glass filled polymer, such as by way of non-limiting example, Polyolefin, thermoplastic elastomers, thermoplastic vulcinates, polymers and copolymers of polylactic acid, polystyrene, polyester, polyoxamethalyne, cellulosics, polyamides, polyamideimides, polybutylene-terephthylate, polyester elastomers, linear low density polyethylene, thermoplastic polyurethane, bi-axially oriented polypropylene, ethylene copolymers, Polyvinylchloride, block copolyetheresters derived from hydroxyl-terminated polyethers, polycarbonates, polyestercarbonates, polyketones, polysulfones, polyethersulfones, polyetherketones; unsaturated polyesters derived from copolyesters of saturated and unsaturated dicarboxylic acids, crosslinked acrylic resins derived from substituted acrylates, starch, cellulose, polyhydroxy alcanoates (PHA), polycaprolactone (PCL), polybutylene succinate (PBS)), polymers and copolymers of N-vinylpyrrolidone, polymethylpentene, Methyl methacrylate-acrylonitrile-butadiene-styrene, polytetrafluoroethylene, polyphenylene oxide, polyphenylene sulfide, polyacrylonitrile, polycyanoacrylate, polyvinylpyrrolidone, polydicyclopentadiene, polyimides, aramids, polybutadiene, acrylonitrile-styrene, paracyclophane, parylene, ethylene vinyl alcohol, polyamide (nylon), and any combination thereof.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present invention is to be understood as not limited by the specific embodiments described herein, but only by scope of the appended claims.

1. An apparatus for flossing an interproximal space between adjacent teeth in the presence of orthodontic braces and an arch-wire, comprising:
a handle portion;
a floss support portion comprising a first elongate member and a second elongate member separated by an intervening concave recess, the first elongate member comprising a narrow section and a first floss support joined by an intervening bend, the second elongate member comprising a narrow section and a second floss support; and
a floss strand extending under tension at an acute angle from the first floss support to the second floss support at substantially a right angle;
wherein the acute angle facilitates positioning the first floss support between a patient's upper teeth and the arch-wire while simultaneously passing the floss strand into the interproximal space between the teeth; and
wherein the substantially right angle facilitates positioning the second floss support between the patient's lower teeth and the arch-wire while simultaneously passing the floss strand into the interproximal spaces between teeth.

2. The apparatus of claim 1, wherein the floss support portion is positioned at an angle relative to the handle portion so as to facilitate engaging the floss support portion with the interproximal space while comfortably grasping the handle portion in a hand.

3. The apparatus of claim 1, wherein the floss strand comprises a material possessing a tensile strength suitable to withstand tension exerted on the floss strand due to the first and second elongate members, and tension arising on the floss strand during insertion into the interproximal spaces between teeth.

4. The apparatus of claim 1, wherein the floss strand comprises a lubricous coating of wax, parylene, or other similar material.

5. The apparatus of claim 1, wherein the first and second elongate members comprise a flexible material which is rigid enough to maintain the floss strand under a degree of tension suitable to pass the strand into tight interproximal spaces between closely neighboring teeth.

6. The apparatus of claim 5, wherein the intervening concave recess is configured to accommodate the teeth when the floss strand is within the interproximal space between the teeth.

7. The apparatus of claim 1, wherein the narrow sections extend from the intervening concave recess at an acute angle relative to one another, the second floss support being substantially parallel with the narrow section, and the bend positioning the first floss support at an oblique angle relative to the narrow section.

8. The apparatus of claim 7, wherein the acute angle between the narrow sections and the oblique angle position the first floss support at a cumulative angle relative to the second floss support.

9. The apparatus of claim 8, wherein the cumulative angle between the first and second floss supports ranges between 15 degrees and 25 degrees.

10. The apparatus of claim 1, wherein the first and second floss supports each comprises a width resembling a shovel shape, wherein the supports widen in extending from the narrow sections and then taper distal of the floss strand, and wherein a thickness of each of the first and second floss supports is less than a distance between the arch-wire and the patient's teeth.

11. The apparatus of claim 10, wherein the thickness of the first floss support allows the first floss support to pass between the arch-wire and the patient's upper teeth when the floss strand is inserted into the interproximal space between neighboring upper teeth.

12. The apparatus of claim 10, wherein the thickness of the second floss support enables the second floss support to pass between the arch-wire and the patient's lower teeth when the floss strand is inserted into the interproximal space between neighboring lower teeth.

13. The apparatus of claim 1, wherein the floss support portion comprises a flexible material which is rigid enough to maintain the floss strand under a level of tension suitable to pass the strand into tight interproximal spaces between closely neighboring teeth.

14. The apparatus of claim 1, wherein the apparatus is fabricated using standard plastic molding technology.

15. The apparatus of claim 1, wherein the apparatus comprises between 1% and 50% glass filled polymer.

16. The apparatus of claim 1, wherein the apparatus comprises Polyolefin, thermoplastic elastomers, thermoplastic vulcinates, polymers and copolymers of polylactic acid, polystyrene, polyester, polyoxamethalyne, cellulosics, polyamides, polyamideimides, polybutylene-terephthylate, polyester elastomers, linear low density polyethylene, thermoplastic polyurethane, bi-axially oriented polypropylene, ethylene copolymers, Polyvinylchloride, block copolyetheresters derived from hydroxyl-terminated polyethers, polycarbonates, polyestercarbonates, polyketones, polysulfones, polyethersulfones, polyetherketones; unsaturated polyesters derived from copolyesters of saturated and unsaturated dicarboxylic acids, crosslinked acrylic resins derived from substituted acrylates, starch, cellulose, polyhydroxy alcanoates (PHA), polycaprolactone (PCL), polybutylene succinate (PBS)), polymers and copolymers of N-vinylpyrrolidone, polymethylpentene, Methyl methacrylate-acrylonitrile-butadiene-styrene, polytetrafluoroethylene, polyphenylene oxide, polyphenylene sulfide, polyacrylonitrile, polycyanoacrylate, polyvinylpyrrolidone, polydicyclopentadiene, polyimides, aramids, polybutadiene, acrylonitrile-styrene, paracyclophane, parylene, ethylene vinyl alcohol, polyamide (nylon), or any combination thereof.

17. A method for flossing an interproximal space between adjacent teeth in the presence of orthodontic braces and an arch-wire, comprising:
fabricating a dental flossing assembly comprising a handle portion and a floss support portion;
positioning the floss support portion at an angle relative to the handle portion so as to facilitate engaging the floss support portion with the interproximal space while comfortably grasping the handle portion in a hand;
separating a first elongate member and a second elongate member on opposing sides of an intervening concave recess, such that the first and second elongate members extend from the concave recess at an acute angle relative to one another, the first elongate member comprising a narrow section and a first floss support, the second elongate member comprising a narrow section and a second floss support, the intervening concave recess sized to accommodate the adjacent teeth during flossing;
joining the first floss support and the narrow section together way of an intervening bend so as to position the first floss support at an oblique angle relative to the narrow section;
extending a floss strand under tension at an acute angle from the first floss support to the second floss support at substantially a right angle;
positioning the first floss support between a patient's upper teeth and the arch-wire while passing the floss strand into the interproximal space between the upper teeth; and
positioning the second floss support between the patient's lower teeth and the arch-wire while passing the floss strand into the interproximal space between the lower teeth.

18. The method of claim 17, wherein joining further comprises forming a cumulative angle between the first and second floss supports ranging between 15 degrees and 25 degrees.

19. The method of claim 17, wherein fabricating further comprises using standard plastic molding technology.

20. The method of claim 17, wherein fabricating further comprises forming a thickness of the first and second floss supports which is less than a distance between the patient's teeth and the arch-wire.
